(19) United States
(12) Patent Application Publication
(10) Pub. No.: US 2025/0360980 A1
(43) Pub. Date: Nov. 27, 2025

(54) Trailer

(71) Applicant: Lucia Innovations LLC, Front Royal, VA (US)

(72) Inventor: John J. Landree, Memphis, TN (US)

(73) Assignee: Lucia Innovations LLC, Front Royal, VA (US)

(21) Appl. No.: 19/205,343

(22) Filed: May 12, 2025

Related U.S. Application Data
(60) Provisional application No. 63/650,017, filed on May 21, 2024.

(51) Int. Cl. B62D 63/08; B60D 1/24; B62D 63/06

(52) U.S. Cl. CPC B62D 63/08; B60D 1/245; B62D 63/062

(57) ABSTRACT

An improved trailer construction can have a forward locking configuration while still permitting selective tie rod pivoting of forward and rear tie rods in forward and rearward configurations. A shock assembly may assist in coupling a hitch assembly to a trailer frame to assist in keeping wheels of the trailer on the ground. Also, by providing an improved trailer frame, a lower aspect can be achieved than in prior art constructions.

### CLAIM OF PRIORITY

This application claims the benefit of U.S. Provisional Application No. 63/650,017 filed May 21, 2024, incorporated herein by reference in its entirety.

### FIELD OF THE INVENTION

The invention generally relates to the field of automotive trailers and improvements thereto.

### BACKGROUND OF THE INVENTION

A little over a decade ago, the applicant's predecessors developed the technology behind U.S. Pat. No. 9,016,711, incorporated herein by reference, in an effort to address backing issues, particularly for small trailers. Specifically, common trailers use a ball shaped hitch to allow relative motion between the towing vehicle and the trailer during maneuvering. The freedom of the trailer in three axes creates a challenge to backing up the vehicle/trailer pair. If the vehicle and the trailer are not aligned, then the direction of travel for the vehicle/trailer pair is limited during backing. An example could be a situation where the vehicle turned to the left to enter a parking space in a parking lot. With the vehicle fully in place, the trailer may or may not have come completely behind the vehicle. If the trailer is still at an angle relative to the vehicle, then the driver is forced to back out of the parked position in the same direction entered. If the desire is to back out the opposite direction, then there are not normally options for this maneuver. Common trailers carry the majority of the load on their own axle and limit the weight applied to the bumper/receiver of the towing vehicle. For small loads and light weight use, small platforms are frequently used which are rigidly inserted into the receiver of the host vehicle. These platforms have the advantage of allowing for easy maneuvering and backing but have the inherent limitation of light load limits since the entirety of the load is carried by the host vehicle. Vehicle carries more weight in the rear than it was designed to and uneven load distribution leads to dangerous instability.

For instances where the load is heavy yet still relatively small, a need exists to enable a small trailer to be used which carries the entire load on its own axles yet is constrained to follow directly behind the towing vehicle by separating the three axes of rotation and limiting one of those axes, thus making it quite easy to park the vehicle in tight spaces and back out in either direction desired. Such a trailer construction is not known to exist by the applicant.

U.S. Pat. No. 9,016,711, incorporated herein by reference in its entirety, solved some of these problems, but there remained difficulties experienced when attempting to commercialize the prototype designed using that technology. Specifically, the original hitch assembly 101 experienced so much sheer force that the bolts sheered off during testing. Also, when driving at high speed, a bump in the road caused the trailer to bounce to almost a vertical position with the frame almost perpendicular to the road. When the wheels returned to the ground, the axle bearings and races shattered under the impact. Additionally, when welding the original hitch assembly together, a high welder setting was required and resulted in undesirable warping, in spite of attempts to hold in place with substantial jig equipment. A new hitch assembly design was deemed desirable for many embodiments.

The trailer frame 202 was also determined to be too low relative to the street in many locations. A new frame design was deemed to be desirable for many embodiments.

An actuator system was initially used to transition from forward to reverse trailer operation which was an electro-hydraulic system which used engine coolant contained within a small reservoir. The system barely functioned and leaked constantly. An improved actuator system was deemed to be desirable for many embodiments.

Finally, tie rods 305,306 were initially made from 1½ inch steel tubing welded in a fixture/jig. Two CNC machined threaded sockets were welded on each side. These tie rods proved to be extremely expensive to manufacture. During testing, weld joints in the tie rods failed under stress. Also, the tie rods connected to spindle blocks which were manufactured from billet steel and CNC machined which proved to be extremely expensive and still produced undesired fishtailing and wheel shimmy, even with adjustable length tie rods. Initial efforts at providing improved spindle blocks also failed of the prior art construction also failed.

Accordingly, a need exists for improved trailer constructions for use with vehicles which can be mass produced and be reliable.

### SUMMARY OF THE INVENTION

It is an object of many embodiments of the present invention to provide an improved trailer and/or trailer steering system for use with trailers.

It is yet another object of many embodiments of the present invention to provide a trailer configuration wherein at least the rotation, or horizontal pivot axis may be restrained at limits while still providing turning capability of the trailer.

It is another object of many embodiments of the present invention to provide a trailer having an improved actuator system for coordinating separate forward and reverse operation.

It is yet another object of many embodiments of the present invention to provide an improved manufacturing method for many parts of the trailer so as to enable rapid and cost efficient construction while providing a reliable trailer to the marketplace.

It is another object of many embodiments of the present invention to provide a trailer having elevated frame portions relative to a wheel axle.

It is another object of many embodiments of the present invention to provide an improved trailer having improved spindle blocks whereby the wheel alignment is precisely set via CNC manufacturing rather than by hand.

It is another object of many embodiments of the present invention to provide improved trailer having improved tie rods whereby the wheel alignment is precisely set via CNC manufacturing rather than by hand.

Still, it is another object of many embodiments of the present invention to provide a trailer with an improved shock absorbing system for the receiver assembly to assist in maintaining the trailer on the road, as opposed to bouncing upwardly in an uncontrolled manner at speeds.

Accordingly, in accordance with a presently preferred embodiment of the present invention, an improved hitch may allowing roll along the roll axis (longitudinal pivot axis) possibly up until predetermined stops while continuing to lock the vertical pivot axis (yaw). The lateral axis (pitch) may remain free to rotate but only up to a point when an absorbing shock bracket limits excessive pitch (aka removing a tendency to upwardly bounce, possibly out of control).

An additional benefit to enable vehicles of various sizes or hitch heights may be to offset the round portion of the receiver tang from the square portion and/or also to offset the pivot point of the trailer collar from its rotation axis. When either the receiver tang or the trailer collar is inverted the relative height of the hitch assembly from the ground can be adjusted to at least attempt to match the height of the receiver on the towing vehicle for at least some embodiments.

Additionally, optional wheels whether retractable, or not, may extend from the bottom so that the device may be rolled. A top handle may pivotably rotate relative to a base to allow for the carrier to be pulled although other embodiments could be pushed. When pulling, an upward force tends to be applied which can assist in moving the pet carrier particularly when a pet is in the carrier.

When a trailer is secured behind the towing vehicle with a rigid yaw axis the trailer tires will normally undergo side loads based on their relative distance behind the towing vehicle's rear tires compared to the distance from the front to the rear tires of the towing vehicle. This side load is due to the fact the towing vehicle rear tires do not rotate or steer so the entire system pivots about that point. For a trailer mounted as described, the tires would normally traverse a larger radius arc than the towing vehicle rear tires and will subsequently experience side loads relative to the ratio of the arc radius difference. When a vehicle stops during a turn and begins to back up in the opposite direction of turn (i.e. “three point turn”) the trailer tires instantly experience side loads in the opposite direction. To prevent side loads and the likely subsequent wear of the tires, it would appear to be advantageous to steer the tires of the trailer; however, the steering system must be capable of transitioning the trailer from one direction turn to the other without solely relying on the motion of the towing vehicle, as in the three point turn example described above.

The applicant has an optional improved steering system which improves the steering of trailers towed behind a vehicle for many embodiments.

Preferred embodiments of the applicant's design embodies a trailer where the steering may be laid out as a trailing link caster type system with both tires connected via a forward and a rear lateral tie rod. For forward operations, the forward tie rod may be held rigid for some embodiments while the rear tie rod may be allowed to translate left and right as the tires pivot about the forward tie rod attach points. For reverse operations the rear tie rod may be held rigid for some embodiments while the forward tie rod is allowed to translate left and right as the tires pivot about the rear tie rod attach points.

At the point of transition from forward to reverse operations, a motor or other device may preferably be employed to quickly center the offset tie rod and secure it for some embodiments, while releasing the rigidly held tie rod, thus allowing the trailer to begin translations. Once in either forward or reverse state, the trailing link castering tires are preferably able to follow the necessary curvature passively, avoiding any side loads and minimizing tire wear. Described herein as a servo electric motor, the steering system may employ an improved efficiently operating high torque electric motor that drives a sliding latch to selectively lock one tie rod, the other tie rod, or with this improvement, possibly both. Other mechanisms may be employed with other embodiments. Additionally, a speed senor, and possibly a processor, makes it possible to automatedly transition from the forward to reverse configurations (without separate input from the vehicle) for at least some embodiments, as well as lock both tie rods at a specific objective, such as a predetermined speed, etc.

Improved manufacturing techniques apart from welding up certain components proved to provide increased reliability as well as decreased production/assembly times. Tie bars, frame members, and portions of the hitch assembly may preferably be cast rather than welded, and for at least tie bars, for many embodiments, rather than forged. Many portions of the frame may be elevated relative to the wheel axle by having four 45 degree bends (or other bends) so as to create a well where the wheel axle may connect to the frame while elevating other portions of the trailer frame.

Finally, improved spindle blocks may receive the tie rods and connect to prelubricated hub assemblies widely available in the market to remove spindles, bearings and races, seals, washer, castle nut, cotter pin and dust cap previously required, for at least many embodiments.

### BRIEF DESCRIPTION OF THE PREFERRED EMBODIMENT

The particular features and advantages of the invention as well as other objects will become apparent from the following description taken in connection with the accompanying drawings in which:

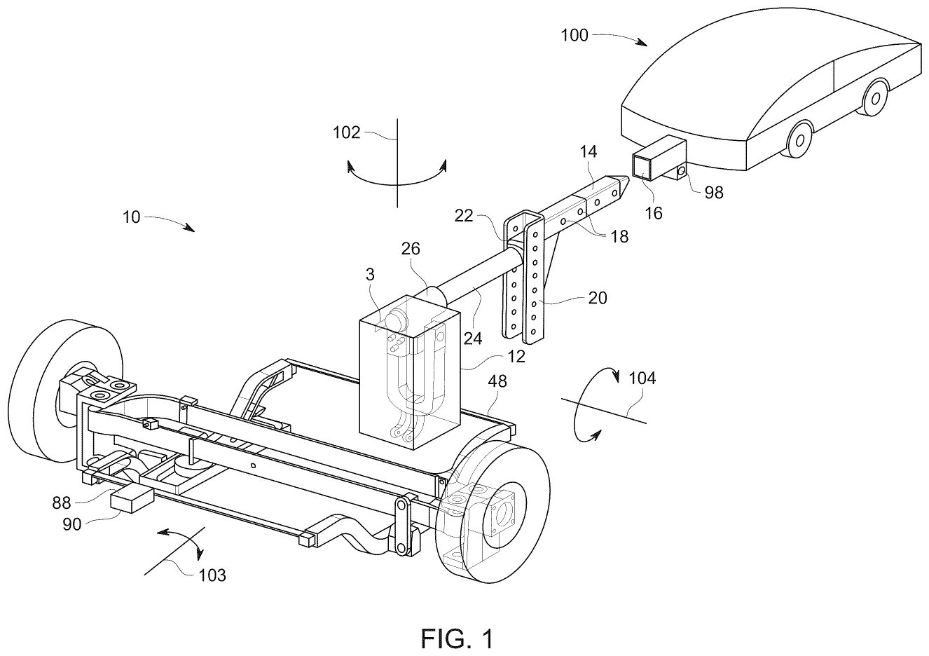

FIG. 1 is a rear perspective view of a presently preferred embodiment of a trailer with a box representing the shock absorbing pitch limiter on the hitch assembly;

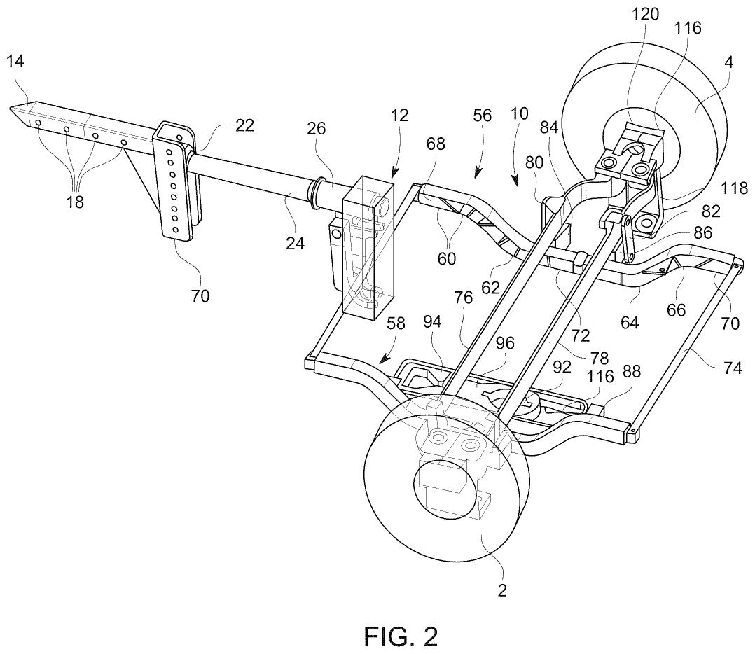

FIG. 2 is a front perspective, view of a presently preferred embodiment of a trailer with a box representing the shock absorbing pitch limiter on the hitch assembly;

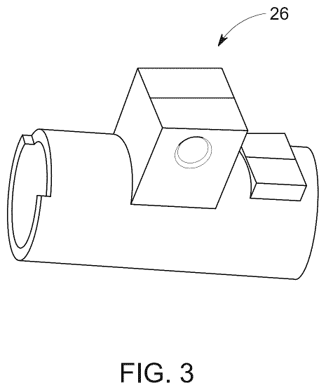

FIG. 3 is a bottom perspective view of the collar removed from the trailer of FIGS. 1-2;

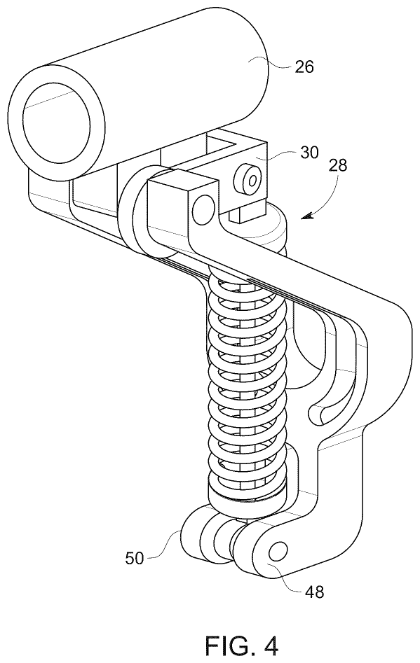

FIG. 4 is a front perspective view of the collar and pitch shock absorber shown in detail as would be present in FIGS. 1-2;

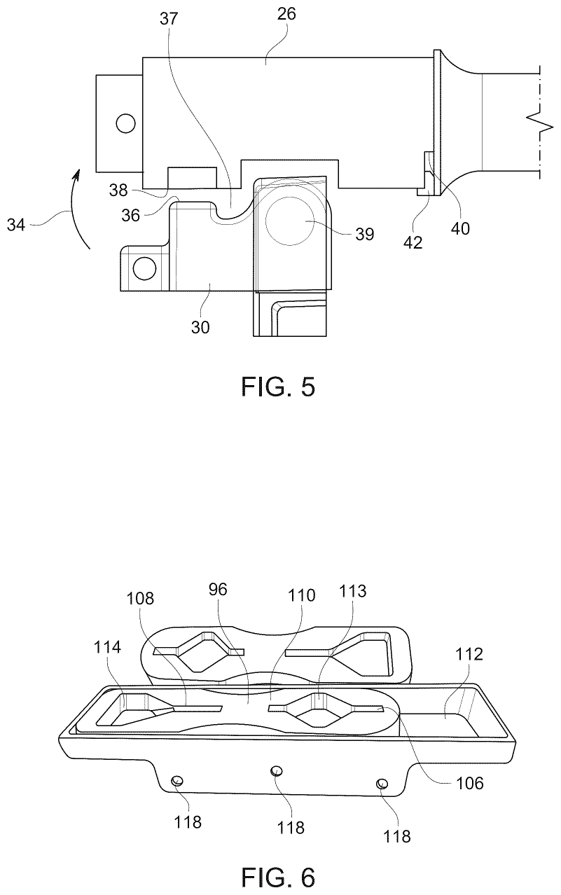

FIG. 5 is a side plan view of the collar installed in the trailer of FIGS. 1-2 with the shock absorber removed;

FIG. 6 is a side perspective view of the latch assembly removed from the trailer of FIGS. 1-2;

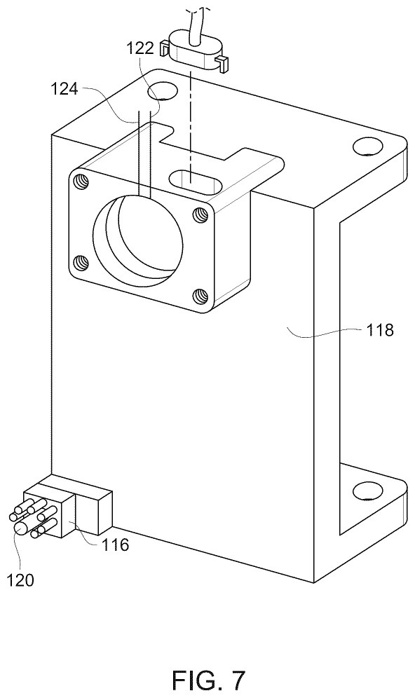

FIG. 7 is an outside perspective exploded view of an improved spindle block as it would connect to a wheel hub and speed sensor and the trailer of FIGS. 1-2; and

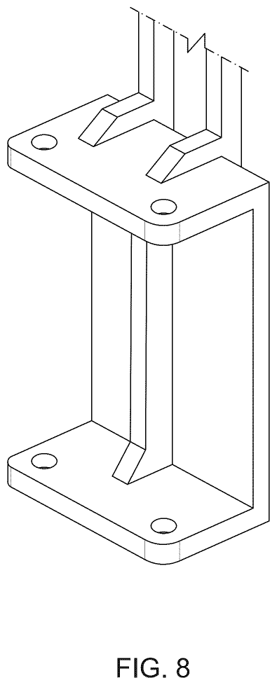

FIG. 8 is an inside perspective exploded view of an improved spindle block of FIG. 7 as it would connect to tie rods shown in FIGS. 9-10.

### DETAILED DESCRIPTION OF THE PREFERRED EMBODIMENT

FIGS. 1-2 show a trailer 10 having an improved hitch assembly 12 which may be better understood with reference to component parts shown in FIGS. 3-5. Three primary axes of motion between the vehicle 100 and the trailer 10 at the interface of the trailer 10 and vehicle 100 at the hitch assembly 12 are illustrated. The vertical pivot axis 102 shows yaw motion. The longitudinal pivot axis 103 shows roll motion. The lateral pivot axis 104 shows pitch motion.

The trailer hitch shank 14 of the hitch assembly 12 is inserted into the hitch receiver 16 for many embodiments and locked with a hitch pin (not shown) in one or more of the bores 18 in the hitch shank 14. Elevational adjustment may be provided with selecting bores in the spine 20 to align with the tang end 22 and directing a pin (not shown) therethrough. Tang shaft 24 receives collar 26 thereabout, preferably opposite to tang end 22.

Collar 26 differs from collar of U.S. Pat. No. 9,016,711 in that it cooperates with shock assembly 28 having shock bracket 30 and spring 32 so that when trailer 10 pitches upwardly in direction 34, shock strut 36 contacts bumper 38 of collar 26 if a predetermined amount of rotation in direction 34 is met. This keeps the trailer 10 from bouncing up vertically as occurred with earlier prior art efforts. The inertia and energy of the upward motion in direction 34 is cancelled and arrested by the adjustable tension recoil of the coil-over shock and then overcome to create downward force dampened by the coil over shock. This feature may assist in forcing the wheels of the trailer 10 to stay on the ground to maintain a good ride quality and/or assist in stabilizing the trailer 10. Meanwhile collar 36 permits rotation of tang shaft 24, at least within a limited arc of rotation as discussed below.

Gap 37 between bumper 38 (which may be the same material as the rest of collar 26, or not), and shock bracket 30 permits at least limited rotation of the collar 26 on the lateral pivot axis 104 via the pivot 39, such as the axis of the 1 inch bolt illustrated, to permit a certain amount of free travel for at least some embodiments, possibly in either direction without tension applied from the spring 32 (illustrated as a shock strut). In FIG. 5, during at least some bounces of the trailer 10, the collar 26 rotates counter clockwise, or the trailer 10 rotates clockwise in direction 34, etc., and the bumper 38 contacts the shock bracket 30 to arrest and dampen such motion, thereby assisting in keeping wheels 2,4 on the ground to assist in control and stability. This type of control is not believed to be possible with traditional ball and socket trailer hitch assemblies.

Collar 26 also has turning limits 40 which contact stop(s) 42 of tang shaft 24 to limit roll about longitudinal pivot axis 103 to a predetermined amount of roll, and no more in an effort to control the amount of roll of the trailer 10 relative to the vehicle 100. Such a construction prevents roll-over of a trailer 10. Limits 40 and/or stop(s) 42 could be provided through tabs, notches, slots, pins 1,3 (which could contact shock bracket 30, or other stop(s) 42) and/or other constructions as would be obvious to those of ordinary skill in the art.

FIG. 4 shows spring 32 connected to the shock bracket 30 and the U member 44. Bracket 30 also connects to the U member 44. U member 44 connects at intermediate location 46 to front frame cross member 48. U member 44 is shown connecting at one end to bracket 30. At other end of shock bracket 30 is where the bracket 30 is shown connected to spring 32. Other end of U member 44 is shown connected to opposite end of spring 32 for at least some embodiments. The shock bracket 30 may be a full-floating shock bracket system. Some embodiments may have shock bracket 30 constructed of ⅜ inch cold rolled steel bar and cross braced with ⅜ inch, then welded together. A ⅜ strip of hard rubber may be retained on one side by a similarly shaped piece of ⅜ inch steel strap and bolted n place. Such a construction has been found to assist in further dampening and to deaden mechanical noise. Steel castings replaced welded prototypes over time. U member 44 or horseshoe U bracket originally had ⅜ inch threaded holes, but those were replaced with 1 inch holes all the way through which permitted a floating 1 inch bolt. Bracket ears 48,50 received the bottom of spring 46 for at least some embodiments. Legs 52,54 of U member receive the shock bracket 30 there between for at least some embodiments.

Frame sides 56,58 differ from U.S. Pat. No. 9,016,711 in that there are four forty-five degree bends 60,62,64,66 (See FIG. 2). This allows side frame end segments 68,70 to connect to front frame member 48 and rear frame member 74 at a higher elevation than side frame middle segment 72. Side frame middle segment 72 connects to tie rods 76,78 for at least some embodiments so that tie rods 76,78 are no higher than side frame end segments 68,70, if not lower than side frame end segments 68,70, which is different than U.S. Pat. No. 9,016,711 where the tie rods are disposed completely above the frame, thereby requiring larger diameter tires to attempt to prevent dragging the frame on the ground in that design. The improved frame sides 56,58 provide for greater ground clearance of much of trailer 10. Tie rods 76,78 connect to side frame middle segments 72 at ears 84,86 through shoulders 80,82.

The steering and actuator system of preferred embodiments of the present invention also is different than in U.S. Pat. No. 9,016,711. An electric actuator 88 was discovered from the solar panel industry segment for moving solar panels to point them towards the sun which operated at a high torque and low energy consumption level which would remain within the 10 amp reverse and brake light circuit which prevented a need for a long power wire from the battery to the trailer plug at the rear of vehicle 100 for many embodiments (such a wire could potentially void the manufacturer's warranty on vehicle 100). The electric actuator 88, servo electric, also allowed replacement of the electro-hydraulic system used with the prototype of U.S. Pat. No. 9,016,711 which leaked constantly.

Operation of the steering actuator system is a lot like the system shown in U.S. Pat. No. 9,016,711 (See FIGS. 10A-10G and related description). Rear latch 92 on rear tie rod 78 may lock the rear tie rod into slot 106 of actuator block 96 after selecting reverse in the vehicle 100 which is communicated through the vehicle electronics at trailer electric connection 98 or otherwise. When the vehicle 100 is taken out of reverse, signals received have the actuator block 96 move rearwardly relative to the latch 92 to disengage from slot 106 possibly while maintaining the front latch 94 in slot 108 (or both in cavities 112,114) until rear latch 92 engages slot 110 similarly as shown in FIGS. 10A-10G of U.S. Pat. No. 9,016,711. Actuator block 96 moves within tray 114 as moved by actuator 88 and drive shaft 116 (as shown in FIG. 2). The rear latch 92 moves forward relative to slot 106 preferably automatically once the gear shift is moved out of reverse for many embodiments. This feature, if implemented, eliminates reliance on the brake light signal of vehicle 100 to be used to assist in moving the latch into the “drive” position.

The actuator block 96 may replace the Vee-Block steering actuator 31 shown in operation in FIG. 10A-10F of U.S. Pat. No. 9,016,711. The interface front latch 94 of the front tie rod 76 may be constrained by the machined locking slot 108 in the actuator block 96. Meanwhile the rear tie rod 78 and its rear latch 92 are free to translate laterally within the confines of the continuously widening gap of the cavity 113 unless locked into the slot 106 as described above (such as if above 35 miles per hour or other limitation) See FIG. 6. This would allow the tires 2,4 to passively trail along and freely caster their steering angle as necessary. The left and right tire 2,4 are preferably constrained to stay at the same angle relative to each other, except for the speed related toe-in effect described herein yet they are free to passively steer as a pair.

During the transition from the forward drive configuration to the rearward drive configuration, the forward tie rod front latch 94 is released from the slot 108 while the rear latch 92 is driven into slot 110. The forward tie rod 76, having been previously released from its locking slot 108 is now free to translate laterally within the confines of the continuously widening cavity 114 on the forward segment of the actuator block 96. The actuator 88, which now has drive shaft 116 extended, holds the actuator block 96 in the rearward position and secures the rear tie rod 78 allowing the forward tie rod 76 to act as a trailing link for reverse direction travel which allows the tires 2,4 to passively trail along and freely caster their steering angle as necessary. The left and right tires 2,4 remain constrained to stay at the same angle relative to each other, except for the speed related toe-in effect described herein, which now functions to create a “toe-out” effect which in turn stabilizes the trailer while backing yet allows the tires to continue to be free to passively steer as a pair. Other embodiments utilize other structure of these features are employed.

Thus there has been described a trailer passive steering system that significantly eases the skill required to back up by allowing the vertical pivot axis of the trailer to be locked and thus locating the trailer 10 always directly behind the towing vehicle 100 yet simultaneously allowing the tires 2,4 to freely caster their steering angle based on the motions of the towing vehicle 100, both in forward and reverse direction of travel.

The new tray 112 shown in FIG. 6 is an improvement over the tray shown in U.S. Pat. No. 9,016,711 in that it bolts onto frame side 58 at bores 118 instead of being welded on via brackets as was done in the '711 Patent.

FIG. 7 shows a wheel hub 116 and speed sensor 118 removed from the wheel 4 and spindle block 118. Using signal(s) from the speed sensor 116, preferably provided to processor 90, the actuator 88 can move the actuator block 96 to lock both tie rods such as is shown in FIG. 2 with front latch 94 in slot 108 and rear latch 92 in slot 106. This feature is believed to be new. Speed sensor 118 can also be used by processor 90 to position actuator block 96 into forward and rearward modes of operation, for at least some embodiments. The speed sensor 188 and processor 90, possibly a microcontroller, may provide information, input/output and/or control multiple functions through programming as would be understood by those of ordinary skill in the art. By using speed sensor, no data from the vehicle 10 need be provided for at least some embodiments to move actuator block 96, which differs from embodiments of the prior in of the '711 patent.

Spindle blocks 118 replace prior art spindle blocks found in U.S. Pat. No. 9,016,711. The prior art spindle blocks were manufactured from billet and CNC machined at a production prohibitive cost as test parts. A 1 inch straight spindle was welded into the block to mount the wheel hub. Fishtailing and wheel shimmy proved to be difficult to overcome with that design, even when using adjustable length tie rods. Protracted machining time proved to be unsuitable for production units.

In an effort to provide production quality spindle blocks 118, eliminate welding and the resulting warpage, castings for spindle blocks 118 were produced which included the raw spindle in the casting. However, this design proved unfeasible for at least some embodiments requiring machining for wheel hub and bearing installation. Instead, the casting was designed to accept existing wheel hub assemblies 116 currently available in the marketplace. Also, the prior art spindle blocks received the center of the wheel hub at the centerline 122 of the spindle block 118. For the new spindle blocks, the centerline 124 of the wheel hub 116 is offset by at least 0.25 inch, if not 0.5 inch toward the rear 126 of the trailer 10 relative to centerline 122 of the spindle block 118. This rearward move resulted in added leverage and stability for the trailer 10 in the drive/forward motion. Leverage is lessened when moving in the rearward direction, but speeds are normally more limited when moving in reverse. The offset nature of the wheel hub 116 results in a slight increase in toe-in and a substantial increase in stability and handling qualities while, in many embodiments, eliminating wheel shimmy.

The tie rods in U.S. Pat. No. 9,016,711 were made from 1.5 inch steel tubing welded in a fixture/jig. This manufacturing technique produced slight warpage as did welding two CNC machined threaded sockets onto each end. Into the threaded sockets, adjustable tie rod ends were inserted having a threaded rod welded to the CNC machined tie rod end thereby permitting adjustment of the alignment. These tie rods proved to be very expensive to manufacture. Some welded joints also failed in testing. Forged steel and aluminum tie rods, respectively, were explored. They were expensive and difficult to adjust. Cast ends of tie rods were attempted with a spanner bar connecting the cast ends, while permitting adjustments. While these worked better than other alternatives, the applicant then thought about single piece casting of tie rods 74,76 which was what was ultimately decided upon for many preferred embodiments, which worked the best and proved to be efficient after seven earlier generations of testing, experimentation and analysis.

The component parts used in the prototype which used the technology of U.S. Pat. No. 9,016,711 were welded up from component parts. Many parts of the preferred embodiment are cast from various materials, but at least some could be forged. Other components could be composites and be fabricated using CNC billeting, 3D printing or other methodology. Compression molded composites could also be used. Forged composites could be used. Additive manufacturing and/or 3D printed metals could also be used for at least some of the parts shown herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

Having thus set forth the nature of the invention, what is claimed herein is:

What is claimed is:

1. A trailer for towing behind a vehicle comprising:
a hitch assembly for connecting to a receiver of a vehicle;
a trailer frame connected to the hitch assembly, said trailer frame supported by wheels;
wherein the trailer frame is connected to the hitch assembly with a shock bracket assembly having a collar which receives the hitch assembly permitting rotation of the hitch assembly about a pivot axis within the collar at least along an arc; and
a shock bracket having a strut, said strut separated by a gap from a bumper until rotation along a lateral pivot axis causes the strut to contact the bumper thereby limiting rotation of the shock bracket and trailer frame relative to the collar.

2. The trailer of claim 1 further comprising a spring connected to the shock bracket, said spring assisting in dampening rotation of the shock bracket relative to the trailer frame.

3. The trailer of claim 2 wherein the shock bracket connects to a first end of a U member at a first end of the shock bracket and the spring at a second end of the shock bracket, and the collar connects to the first end of the U member.

4. The trailer of claim 3 wherein the spring passes intermediate the U-member to legs of the U member at a second end of the U-member.

5. The trailer of claim 4 wherein a frame cross member connects to the U-member intermediate the shock bracket at the first end of the U-member and the spring at a second end of the U member.

6. The trailer of claim 1 wherein the hitch assembly has a tang shaft received in the collar and stops extend from the tang shaft which cooperate with turning limits of the collar thereby restricting rotation along the pivot axis to the arc.

7. The trailer of claim 1 wherein the trailer frame is connected to the hitch assembly with a shock bracket assembly having a collar which receives the hitch assembly permitting rotation of the hitch assembly about a pivot axis within the collar at least along an are; and said trailer frame having sides operably coupled to tie rods intermediate frame front and rear end segments wherein the tie rods are no higher than the frame front and rear segments.

8. The trailer of claim 1 wherein forward, locked forward and rearward drive configurations are achieved with front and rear tie rods connected at first and second pivots to the left and right wheels respectively and connected to the trailer frame, and an actuator selectively transitions between the forward, locked forward configurations based on receipt of a signal related to speed of the vehicle, where when in the forward configuration and upon sensing a predetermined speed, the actuator moves to the locked forward configuration preventing rotation about the first and second pivots.

9. A trailer for towing behind a vehicle comprising:
a hitch assembly for connecting to a receiver of a vehicle;
a trailer frame connected to the hitch assembly, said trailer frame supported by wheels;
wherein the trailer frame is connected to the hitch assembly with a shock bracket assembly having a collar which receives the hitch assembly permitting rotation of the hitch assembly about a pivot axis within the collar at least along an arc; and
said trailer frame having sides operably coupled to tie rods intermediate frame front and rear end segments wherein the tie rods are no higher than the frame front and rear segments.

10. The trailer of claim 9 wherein the sides of the trailer frame have four forty-five degree bends locating an intermediate portion of the sides lower than the frame front and rear segments.

11. The trailer of claim 9 further comprising a shock bracket having a strut, said strut separated by a gap from a bumper until rotation along a lateral pivot axis causes the strut to contact the bumper thereby limiting rotation of the shock bracket and trailer frame relative to the collar.

12. The trailer of claim 9 wherein forward, locked forward and rearward drive configurations achieved with front and rear tie rods connected at first and second pivots to the left and right wheels respectively and connected to the trailer frame, and an actuator selectively transitioning between the forward, locked forward configurations based on receipt of a signal related to speed of the vehicle, where when in the forward configuration and upon sensing a predetermined speed, the actuator moves to the locked forward configuration preventing rotation about the first and second pivots.

13. A trailer for towing behind a vehicle comprising:
a hitch assembly for connecting to a receiver of a vehicle;
a trailer frame connected to the hitch assembly, said trailer frame supported by wheels;
wherein forward, locked forward and rearward drive configurations achieved with front and rear tie rods connected at first and second pivots to the left and right wheels respectively and connected to the trailer frame, and an actuator selectively transitioning between the forward, locked forward configurations based on receipt of a signal related to speed of the vehicle, where when in the forward configuration and upon sensing a predetermined speed, the actuator moves to the locked forward configuration preventing rotation about the first and second pivots.

14. The trailer of claim 13 further comprising front and rear slots driven by the actuator relative to the rear tie rod assisting in selectively locking rotation about first and second pivots for the rearward and locked forward configurations.

15. The trailer of claim 13 further comprising an electrically driven actuator.

16. The trailer of claim 13 further comprising a shock bracket having a strut, said strut separated by a gap from a bumper until rotation along a lateral pivot axis causes the strut to contact the bumper thereby limiting rotation of the shock bracket and trailer frame relative to the collar.

17. The trailer of claim 16 wherein the trailer frame is connected to the hitch assembly with a shock bracket assembly having a collar which receives the hitch assembly permitting rotation of the hitch assembly about a pivot axis within the collar at least along an arc.

18. The trailer of claim 13 wherein said trailer frame has sides operably coupled to tie rods intermediate frame front and rear end segments wherein the tie rods are no higher than the frame front and rear segments.
